(19) United States
(12) Patent Application Publication
(10) Pub. No.: US 2013/0020982 A1
(43) Pub. Date: Jan. 24, 2013

(54) EQUALIZATION SYSTEM FOR ACCUMULATOR BATTERIES

(71) Applicants: Sylvain Mercier, Saint Egreve (FR); Daniel Chatroux, Teche (FR); Julien Dauchy, Chatte (FR); Eric Fernandez, Saint Paul De Varces (FR)

(72) Inventors: Sylvain Mercier, Saint Egreve (FR); Daniel Chatroux, Teche (FR); Julien Dauchy, Chatte (FR); Eric Fernandez, Saint Paul De Varces (FR)

(73) Assignee: Commissariat a l'energie atomique et aux energies alternatives, Paris (FR)

(21) Appl. No.: 13/577,185

(22) PCT Filed: Feb. 4, 2011
(86) PCT No.: PCT/EP2011/051684

§ 371 Date: Oct. 12, 2012

(30) Foreign Application Priority Data
Feb. 5, 2010 (FR) 1000481

(51) Int. Cl. H02J 7/00

(52) U.S. Cl. 320/103

(57) ABSTRACT

An apparatus comprising a charge equalizing system for batteries has two accumulator stages in series. Each stage has a charging device having an inductance for storing energy, and first and second diodes. The first diode's anode links to a negative pole of the accumulator stage. Its cathode links to the inductance's first end. The second diode's cathode links to a positive pole of the accumulator stage; its anode links to the inductance's second end. A first controlled switch links to a battery's negative pole and to the second diode's anode. A second controlled switch links to the battery's positive pole and to the first diode's cathode. A control device controls the charging devices. The control device closes the switches of a charging device associated with the accumulator stage to be charged so that the inductance stores energy, and opens the switches to transfer the energy to the associated accumulator stage.

The invention relates to an equalizing system for electrochemical accumulator batteries that can be used notably in the field of electrical and hybrid transport and the embedded systems. The invention relates in particular to the batteries of lithium-ion (Li-ion) type which are well suited to this kind of application, because of their ability to store high energy with a low mass. The invention is also applicable to supercapacitors.

An electrochemical accumulator has a nominal voltage of the order of a few volts, and more specifically 33 V for the Li-ion batteries based on iron phosphate and 4.2 V for an Li-ion technology based on cobalt oxide. If this voltage is too low compared to the requirements of the system to be powered, a number of accumulators are placed in series. It is also possible to arrange in parallel with each associated accumulator in series one or more accumulators in parallel in order to increase the available capacity and to supply higher current and power. The associated accumulators in parallel thus form a stage. A stage consists of at least one accumulator. The stages are connected in series to achieve the desired voltage level. The association of the accumulators is called an accumulator battery.

The charge or discharge of an accumulator is reflected respectively in an increase or decrease in the voltage at its terminals. An accumulator is considered to be charged or discharged when the latter has reached a voltage level defined by the electrochemical process. In a circuit using a number of accumulator stages, the current flowing through the stages is the same. The level of charge or of discharge of the stages therefore depends on the intrinsic characteristics of the accumulators, namely the intrinsic capacity and the parasitic series and parallel internal resistances, of the electrolyte or of contact between the electrodes and the electrolyte. Voltage differences between the stages are then possible because of the manufacturing and aging disparities.

For an Li-ion technology accumulator, excessively high or low voltage, called threshold voltage, can damage or destroy the latter. For example, the overload of an Li-ion accumulator based on cobalt oxide can cause thermal runaway thereof and start a fire. For an Li-ion accumulator based on iron phosphate, an overload is reflected in a breakdown of the electrolyte which reduces its life and can damage the accumulator. An excessive discharge which leads to a voltage less than 2 V, for example, mainly causes oxidation of the current collector of the negative electrode when the latter is made of copper and therefore deterioration of the accumulator. Consequently, the monitoring of the voltages at the terminals of each accumulator stage is mandatory when charging and discharging for both safety and reliability reasons. A so-called monitoring device in parallel with each stage provides this function.

The function of the monitoring device is to track the state of charge and discharge of each accumulator stage and to transmit the information to the control circuit in order to stop the charging or the discharging of the battery when a stage has reached its threshold voltage. However, on a battery with a number of accumulator stages arranged in series, if the charging is stopped when the most charged stage reaches its threshold voltage, the other stages may not be totally charged. Conversely, if the discharging is stopped when the most discharged stage reaches its threshold voltage, the other stages may not be totally discharged. The charge of each accumulator stage is then not exploited optimally, which represents a major problem in transport and embedded type applications that have high autonomy constraints. To overcome this problem, the monitoring device is generally associated with an equalizing device.

The function of the equalizing device is to optimize the charge of the battery and therefore its autonomy by bringing the accumulator stages connected in series to an identical state of charge and/or discharge. There are two categories of equalizing devices, the so-called energy dissipation equalizing devices and the so-called energy transfer equalizing devices.

With the energy dissipation equalizing devices, the voltage at the terminals of the stages is made uniform by diverting the charge current from one or more stages that have reached the threshold voltage. As a variant, the voltage at the terminals of the stages is made uniform by discharging one or more stages that have reached the threshold voltage. However, such energy dissipation equalizing devices present the major drawback of consuming more energy than necessary to charge the battery. In fact, it is necessary to discharge a number of accumulators or divert the charge current of a number of accumulators for the last accumulator or accumulators that are a little less charged to finish their charging. The energy dissipated can therefore be very much greater than the energy of the charge or charges that have to he terminated. Furthermore, they dissipate the excess energy as heat, which is not compatible with the integration constraints in transport and embedded type applications, and the fact that the life of the accumulators becomes much shorter when the temperature rises.

The energy transfer equalizing devices exchange energy between the accumulator battery or an auxiliary energy network and the accumulator stages.

The patent U.S. Pat. No. 5,659,237 for example discloses a device that makes it possible to transfer energy from an auxiliary network to stages via a “flyback” structure with a number of outputs and using a coupled inductance as storage element. The latter is a specific component in that it is dedicated to this application. Consequently, the cost of such a component is prohibitive in relation to the function to be fulfilled.

Also, the patent CN1905259 discloses a device that makes it possible to transfer energy from the stages to the battery and that uses an inductance for each accumulator as storage element. However, this device does not opt for an optimized energy transfer for the equalizing of the batteries in the transport and embedded type applications. In practice, the end of charge of a battery is determined by the last stage to reach the threshold voltage. To terminate the charging of a battery, the energy is taken from one or more stages and it is restored to all the stages. When one or more accumulator stages is/are a little less charged, the energy is not then transferred as a priority to the latter which needs/need it but also to the stage or stages from which the energy is taken. The equalizing therefore requires energy to be taken from all the stages at the end of charging in order to avoid charging them to too high a voltage. The equalizing is therefore done with high losses because of the large number of converters in operation. Furthermore, the accumulators already at the end of charge have useless alternating or direct current components passing through them.

The aim of the invention is therefore to propose an enhanced charge equalizing system that does not have these drawbacks of the prior art.

To this end, the subject of the invention is a charge equalizing system for batteries comprising at least two accumulator stages connected in series, each stage comprising an accumulator or at least two accumulators connected in parallel, characterized in that said system comprises:
for each accumulator stage, an associated charging device comprising:
   at least one inductance for storing energy,
   at least one first and at least one second diodes, such that said first diode is linked to the negative pole of said accumulator stage by its anode and by its cathode to one of the two ends of the inductance, and said second diode is linked to the positive pole of said accumulator stage by its cathode and to the other end of the inductance by its anode,
   at least one first and at least one second controlled switches, such that said first switch is linked to the negative pole of the battery and to the anode of the second diode, and said second controlled switch is linked to the positive pole of the battery and to the cathode of the first diode, and in that said system also comprises
a control device controlling said charging devices configured to close said switches of a charging device associated with an accumulator stage to be charged in such a way that said at least one inductance stores energy and to open said controlled switches so as to transfer the energy to the associated accumulator stage.

Said equalizing system may also comprise one or more of the following characteristics, taken separately or in combination:
the control device is configured to simultaneously close said first and second controlled switches of one and the same charging device to be charged,
the control device is configured to open said controlled switches after a predefined conduction time,
said charging device is configured to operate in discontinuous conduction mode, independently of the voltage levels of the associated accumulator stage and of the battery during a charge phase,
the predefined conduction time is calculated such that the charging device for each accumulator stage operates in discontinuous conduction mode,
the control device is configured to close and open said first and second controlled switches of a charging device respectively according to a conduction
time and an open time that are constant during a charge phase, the control device is configured to respectively control the charging devices at the terminals of accumulator stages to be charged, in a way that is staggered in time,
said battery comprises at least one individual module, said at least one individual module comprising a plurality of accumulator stages in series and said system also comprises an additional charging device at the terminals of said at least one individual module,
said battery comprises a plurality of individual modules arranged in series and said system comprises an additional charging device at the terminals of each of the modules of a predetermined number of individual modules,
said at least one inductance has an auxiliary winding for charging an ancillary power supply,
said equalizing system comprises a device for measuring the voltage of each accumulator configured to transmit voltage information to the control device,
the accumulators are of lithium-ion type,
the battery comprises supercapacitors.

The invention also relates to a device for charging a charge equalizing system as defined above.

Other features and advantages of the invention will become more clearly apparent on reading the following description, given as an illustrative and nonlimiting example, and the appended drawings in which:

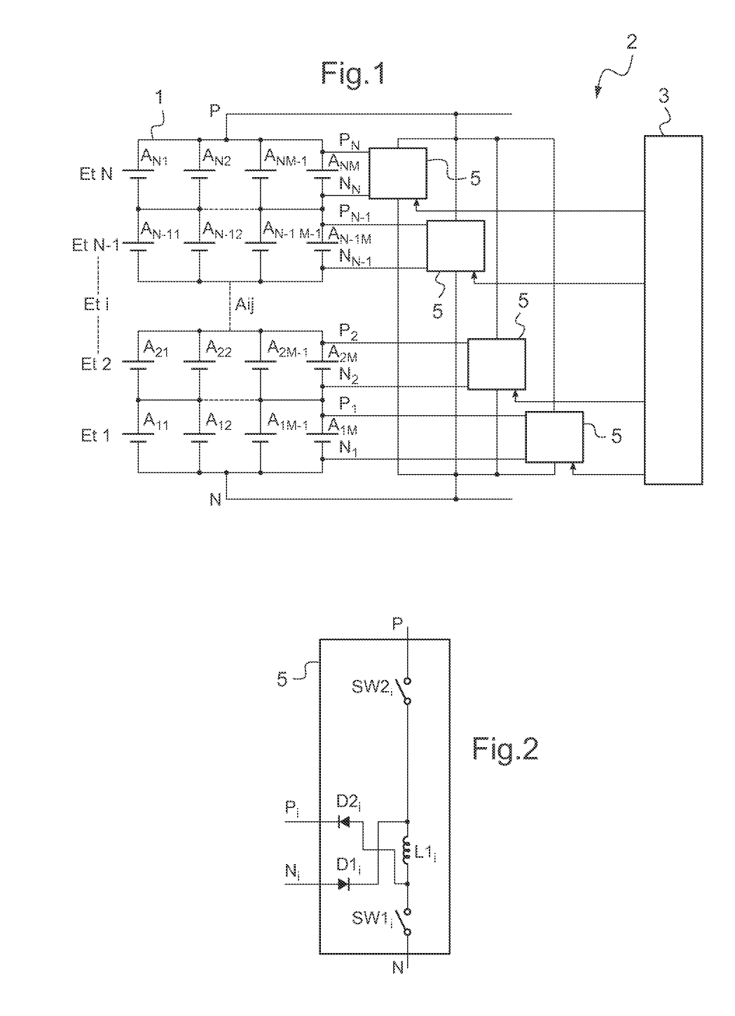

FIG. 1 represents an operating diagram of a battery comprising a series connection of accumulator stages and a battery charge equalizing system,

FIG. 2 illustrates an operating diagram of an exemplary embodiment a charging device of the equalizing system of FIG. 1,

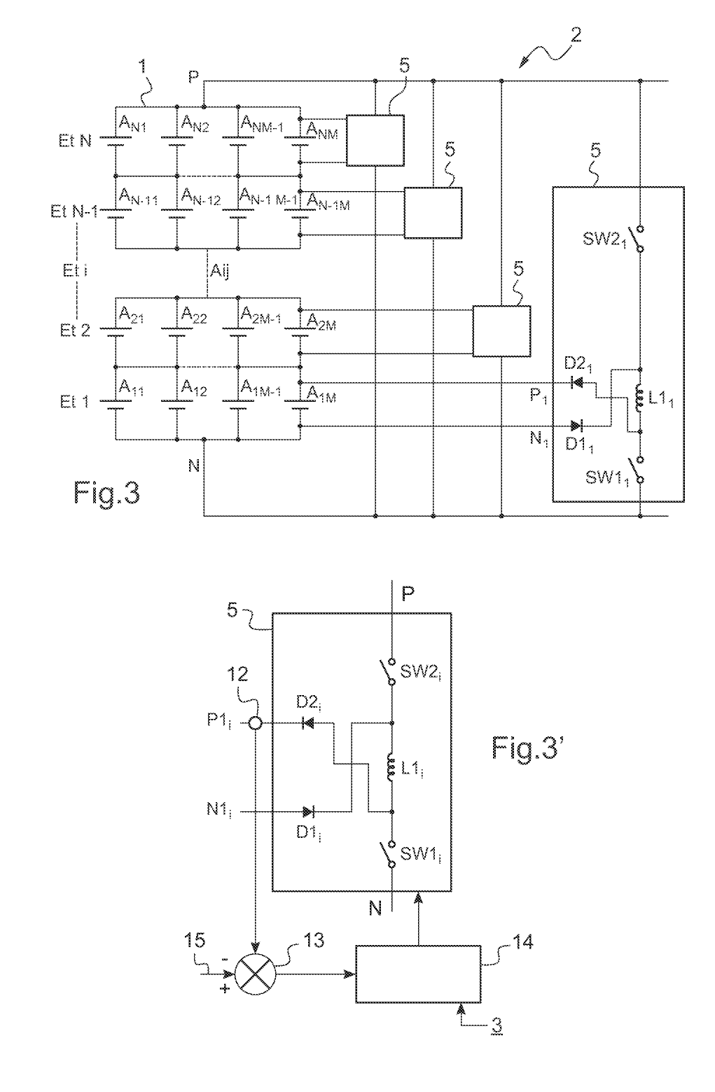

FIG. 3 represents an operating diagram of the battery and of the equalizing system of FIG. 1 with a charging device of FIG. 2,

FIG. 3 illustrates an operating diagram of an exemplary embodiment of a charging device of the equalizing system of FIG. 1 in continuous conduction mode,

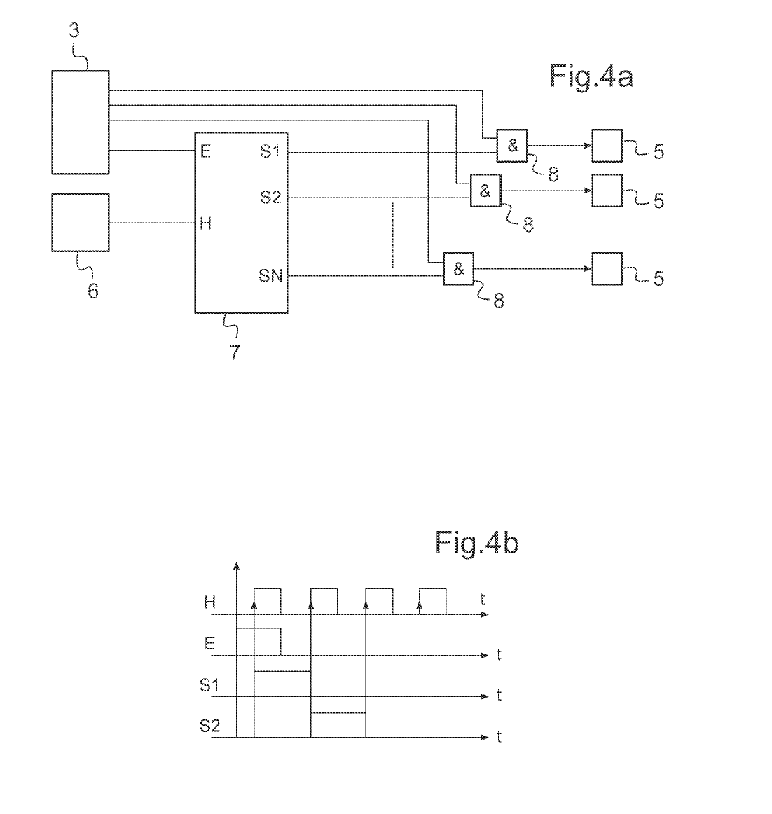

FIG. 4a is a flow diagram schematically illustrating an exemplary embodiment of the control of charging devices of the equalizing system of FIG. 1,

FIG. 4b is a diagram associated with FIG. 4a schematically representing the control signals,

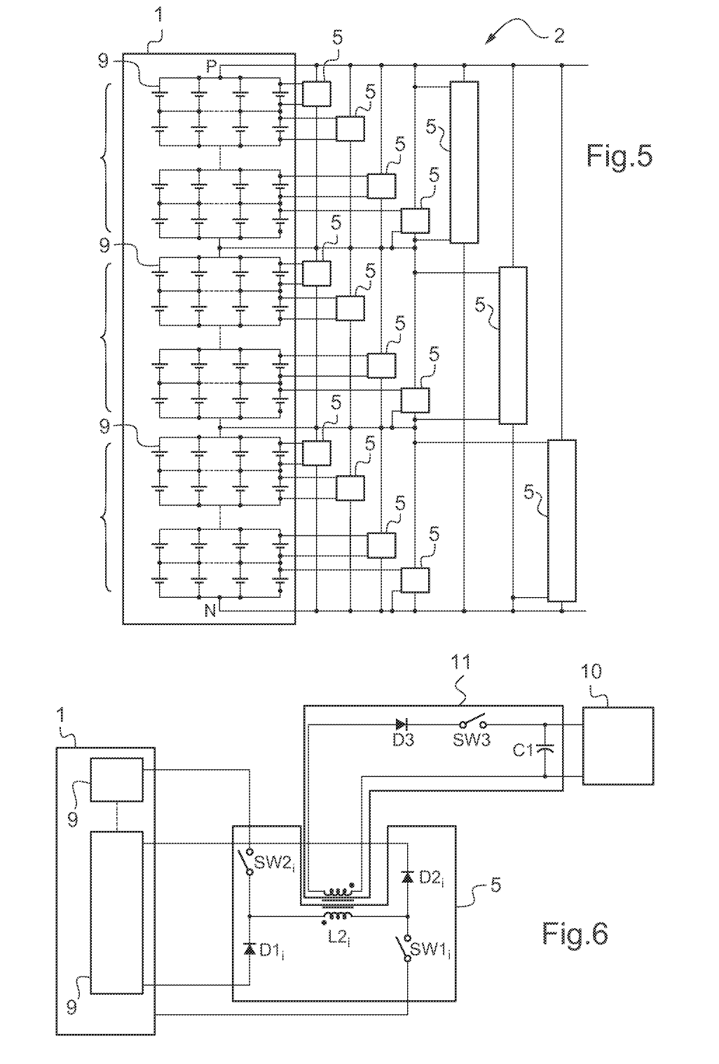

FIG. 5 represents an operating diagram of a battery comprising a plurality of individual modules connected in series each comprising a series connection of a predetermined number of accumulator stages, and a battery charge equalizing system,

FIG. 6 schematically represents an operating diagram of a charging device coupled to an auxiliary network to be powered,

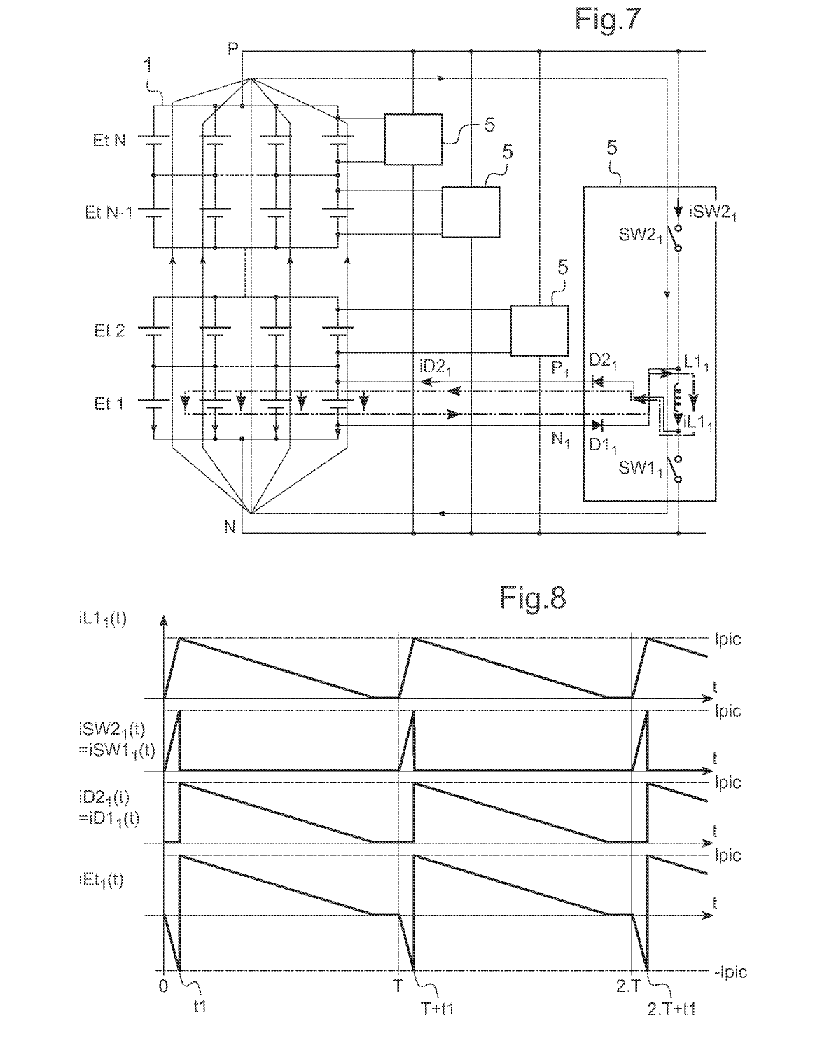

FIG. 7 illustrates an operating diagram of the battery and of the equalizing system of FIG. 3, showing the trend of the different currents when the switches of the charging device are passing and when the diodes of the charging device are passing,

FIG. 8 is a diagram illustrating the trend of the current as a function of time in the charging device of FIG. 2 and in the accumulator stage associated with the charging device.

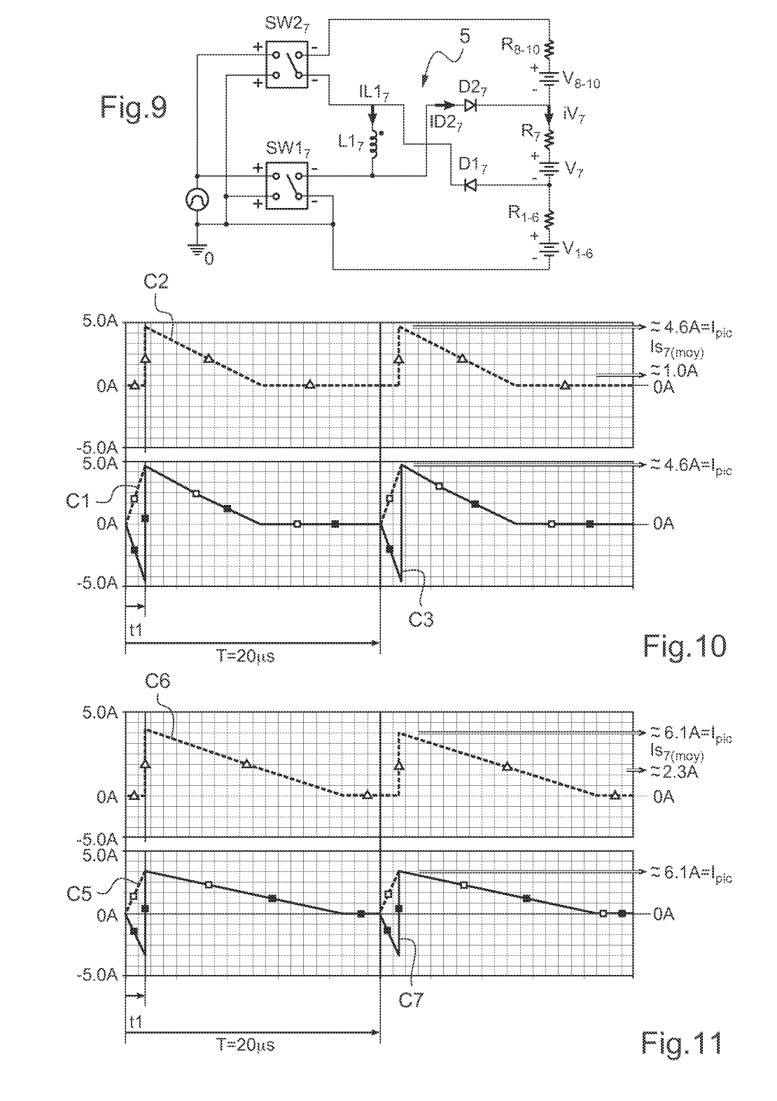

FIG. 9 schematically illustrates the operation of a charging device according to a first simulation and a second simulation,

FIG. 10 illustrates trend curves of the current as a function of time for the first simulation of FIG. 9, and

FIG. 11 illustrates trend curves of he current as a function of time for the second simulation of FIG. 9.

In these figures, the elements that are substantially identical are given the same references.

FIG. 1 represents an accumulator battery 1. This battery 1 is made up of N stages, denoted Etᵢ, connected in series. Each stage Etᵢ is made up of an accumulator or of several accumulators Aᵢⱼ connected in parallel. The index i here represents the number of the stage, this index i varies in the example illustrated in FIG. 1 from 1 to N, and the index j represents the number of each accumulator in a given stage, this index j varying in the example illustrated from 1 to M. The terminals of the accumulators Aᵢⱼ of one and the same stage Etⱼ are connected together via electrical connections, in exactly the same way as each stage Etᵢ is also connected to the adjacent stages Etᵢ via electrical connections.

Charge Equalizing System

The subject of the invention is an equalizing system 2 for such an accumulator battery 1, comprising at least two accumulator stages Etⱼ connected in series.

This equalizing system 2 comprises a control device 3, and a plurality of identical charging devices 5 for each accumulator stage Etᵢ.

Each charging device 5 is connected to the negative pole, denoted Nᵢ, and to the positive pole, denoted Pᵢ, of each accumulator stage Etᵢ, and also to the positive pole, denoted P, and to the negative pole, denoted N, of the accumulator battery 1. The charging devices 5 are controlled by the control device 3.

In the example illustrated in FIGS. 2 and 3, a charging device 5 associated with a stage Etᵢ, for example stage Et₁ in FIG. 3, comprises:
an inductance L1ᵢ, L1₁,
a first diode D1ᵢ, D1₁, the anode and the cathode of which are respectively connected to the pole Nᵢ, N₁ of a stage and to the first end of the inductance L1ᵢ, L1₁,
a second diode D2ᵢ, D2₁, the anode and the cathode of which are respectively connected to the second end of the inductance L1ᵢ, L1₁ and to the pole P1ᵢ, P1₁ of the same stage,
a first switch SW1ᵢ, SW1₁ connected to the anode of the diode D2ᵢ, D2₁ and to the terminal N of the battery,
a second switch SW2ᵢ, SW2ᵢ connected to the cathode of the diode D1ᵢ, D1₁ and the terminal P of the battery.

According to an alternative, two controlled switches are used in place of the diodes D1ᵢ, D1₁ and D2ᵢ, D2₁. A rectification said to be of synchronous type is then possible. The efficiency of the circuit can be increased by reducing the voltage drop in the passing state of the component.

This charging device 5 is differentiated from the prior art inasmuch as it does not have any common reference between the input and the output, as is the case for a “buck-boost” type configuration, and inasmuch as it does not use any transformer, as is the case for a “flyback” type configuration.

A variant embodiment consists in adding a capacitor connected between the positive Pᵢ and negative Nᵢ poles of each accumulator stage. The capacitor is configured to filter the current ripple from the charging device 5. A smooth direct current is thus supplied to each accumulator stage.

It is possible to also add a capacitor (not represented) between the terminals N and P of the battery. It is configured to filter the ripple due to the charging device 5. Thus, the current supplied by the battery is smoothed.

The charging device 5 (FIG. 2) operates equally well in continuous and discontinuous conduction modes.

Operation in discontinuous conduction mode is preferred because it presents the advantage of being easier to implement and to carry out at lower cost. This is because, in discontinuous conduction mode, the current from the inductance L1ᵢ is canceled by definition before each period of the control signal for the switches SW1ᵢ and SW2ᵢ. The value of the current flowing through the inductance L1ᵢ, when the two switches SW1ᵢ and SW2ᵢ are closed, can be deduced from the voltage applied to the terminals of the inductance L1ᵢ, from the energy storage time in the inductance L1ᵢ and from the value thereof.

Thus, and contrary to the operation in continuous conduction mode (FIG. 3′), it is no longer necessary to implement a current sensor 12 associated with a regulation loop 13 and with a current reference variable 15, as well as with a current control device 14, for example a switching in pulse width modulation mode by the transistors SW1ᵢ and SW2ᵢ operating as switches, for each of the accumulator stages Etᵢ in series.

Moreover, in discontinuous conduction mode, the control of the switches SW1ᵢ and SW2ᵢ in pulse width modulation mode can be replaced by a fixed conduction time control.

According to an exemplary embodiment of the control of the charging devices 5 by the control device 3, use is made of a single clock 6, a shift register 7 and controlled switches or “AND” logic functions 8 (FIGS. 4a, 4b).

The shift register 7 avoids having the switches SW1ᵢ and SW2ᵢ of the different charging devices 5 of the different stages Etᵢ closed simultaneously, which would result in an excessive discharge current. The input signal E of the shift register 7 is supplied by the control device 3. The latter also controls one of the two inputs of each “AND” logic function 8. The second input of each “AND” logic function is connected to an output of the shift register 7. The control of a charging device 5 is effective when the two inputs of the “AND” logic function 8 are in the high state.

This control makes it possible to minimize the instantaneous current consumed by the control circuit unlike a control for which all the charging devices 5 are controlled at the same time. Furthermore, this control makes it possible to reduce the effective current supplied by the battery 1 compared to a synchronized control of the charging devices 5, and therefore to minimize its overheating.

Moreover, with reference to FIG. 5, when a large number of accumulator stages Etᵢ in series is used, as is the case for electric vehicles with approximately a hundred accumulators in series for example, the battery 1 may consist of a series connection of individual modules 9, each individual module 9 comprising a series connection of a predetermined number of accumulator stages Etᵢ. A series connection of ten to twelve stages for each individual module 9 is an example.

Thus, the connection of the switches SW1ᵢ and SW2ᵢ of the charging devices 5 is made at the terminals of ten to twelve stages Etᵢ. The voltage withstand strength of the diodes and controlled switches is limited, according to the technology of the Li-ion battery, to approximately 45 V-60 V, which is a standardized voltage withstand strength value in the field of semiconductors. The maintenance of a large number of individual modules 9, as is the case for electric vehicles, is made easier.

According to a variant embodiment, use is made, in addition to the charging devices 5 for each accumulator stage Etᵢ, of identical charging devices 5 by the series connection of N stages Etᵢ forming an individual module 9. FIG. 5 illustrates, as an example, this variant for a connection of the charging devices 5 to the terminals of N accumulator stages of an individual module 9 and for a series association of three individual modules 9, or three times N stages Etᵢ. According to this variant, the connection of the switches SW1ᵢ and SW2ᵢ of the charging devices 5 to the terminals of an individual module 9 is made at the terminals of the battery 1. This variant makes it possible to transfer energy between the N adjacent stages, and therefore between the individual modules 9 that are associated in series.

It is also possible to use one or more of the charging devices 5 implemented at the terminals of a series connection of N stages to supply energy to an auxiliary network 10, such as, for example, the 12 V network for the vehicles (FIG. 6). An ancillary device 11 is then coupled to a charging device 5. The storage inductance of the charging device 5 is replaced in this case by a coupled inductance L2ᵢ. The ancillary device 11 comprises a rectifying diode D3 and a storage capacitor C1, arranged on the secondary of the coupled inductance L2 to form a “flyback” type structure. The supply of energy to the auxiliary network 10 is controlled by a switch SW3 implemented between the rectifying diode D3 and the storage capacitor C1. This switch SW3 is controlled by the control device 3.

Moreover, the equalizing system 2 may comprise a voltage measuring device (not represented) to measure the voltage of each accumulator stage Etᵢ and to transfer voltage information to the control device 3 which can use this voltage information to determine whether an accumulator stage Etᵢ has to be charged and accordingly control the associated charging device 5 when such is the case.

Operation of the Equalizing System in Discontinuous Conduction Mode

The operation of the equalizing system 2 is described below with reference to FIGS. 7 and 8.

When the control device 3 controls a transfer of energy to a stage Etᵢ the stage Et₁ in the example illustrated, the switches SW1₁ and SW2₁ of the charging device 5 in parallel with the corresponding stage Et₁ are closed simultaneously and during a conduction time t1. The circulation of the current during this conduction time t1 is schematically represented by dotted lines in FIG. 7.

The inductance L1₁ henceforth stores energy. The current iL1₁ through the inductance L1 ₁ increases proportionally to the voltage applied to its terminals, equal to the voltage of the N stages (FIG. 8). During this period, the diodes D1₁ and D2₁ are blocked. The diode D1₁ sees at its terminals a voltage equal to the voltage of the stages situated below the stage to which it is connected minus the voltage of the battery. The diode D2₁ sees at its terminals a voltage equal to the voltage of the stages situated above the stage to which it is connected minus the voltage of the battery. At maximum, the reverse voltage seen by the diode D1₁ or D2₁ is equal to the voltage of the accumulator battery.

At the end of the time t1, the switches SW1₁ and SW2₁ open simultaneously. The current iL1₁ in the inductance L1₁ at this instant reaches a peak value Ipeak, equal to the voltage applied to the terminals of the inductance when the switches SW1₁ and SW2₁ are closed, multiplied by t1 and divided by the value of the inductance.

At the end of the time t1 and until the end of the period of operation T of the charging device 5, the switches SW1₁ and SW2₁ are in the open state; the diodes D1₁ and D2₁ are passing until the cancelation of the current in the inductance L1₁. The circulation of the current during this phase is schematically represented by the alternation of two dots and a dash in FIG. 7. The current iL1₁ through the inductance L1₁ decreases proportionally to the voltage applied to its terminals, equal to minus the voltage of the accumulator stage Et₁ minus the voltage drop of the two diodes D1₁ and D2₁ in series therewith (FIGS. 7 and 8). The switch SW1₁ sees, at its terminals, a voltage equal to the voltage of the stages situated below the stage to which it is connected, plus the voltage of the stage to which it is connected and plus the voltage in the passing state of the diode D2₁. The switch SW2₁ sees, at its terminals, a voltage equal to the voltage of the stages situated above the stage to which it is connected, plus the voltage of the stage Et₁ to which it is connected and plus the voltage in the passing state of the diode D1₁. At maximum, the direct voltage seen by the switch SW1₁ or SW2₁ is equal to the voltage of the accumulator battery 1.

The operation of the charging device 5 is identical regardless of the accumulator stage Etᵢ to which it is connected and therefore makes it possible to continue charging certain stages.

Dimensioning

Representation in Equation Form

The dimensioning of the charging device 5 of FIG. 2 results from the representation of its operation described previously as equations. The representation in equation form below is generalized. For this, the input and output voltages are respectively called ye and Vs. Ve represents the voltage between the negative N and positive P terminals of the battery 1. The voltage Vs represents the voltage between the negative Nᵢ and positive Pᵢ terminals of an accumulator stage Etᵢ.

When the switches SW1ᵢ and SW2ᵢ of one and the same charging device 5 are closed during a conduction time t1, the current increases in the inductance L1ᵢ (iL1ᵢ). By disregarding the voltage drop in the passing state of the switches, the current iL1ᵢ(t) in the inductance L1ᵢ is expressed:

$$iL {1}_{i} ( t ) = \frac{Ve}{L {1}_{i}} \times t \qquad ( equation 1 )$$

At the end of the time t1, the switches SW1ᵢ and SW2ᵢ open and the current in the inductance iL1ᵢ reaches the peak value Ipeak:

$$iL {1}_{i} ( t 1 ) = Ipeak = \frac{Ve}{L {1}_{i}} \times t 1 \qquad ( equation 2 )$$

At the end of the time t1 until the current iL1ᵢ is canceled, the diodes D1ᵢ and D2ᵢ of one and the same charging device 5 conduct. The current iL1₁ in the inductance L1ᵢ decreases according to the following law, with Vd being the voltage drop in the passing state of the diode.

$$iL {1}_{i} ( t ) = \frac{Vs + 2 \times Vd}{L {1}_{i}} \times t + Ipeak \qquad ( equation 3 )$$

The operating phase corresponding to a zero current, when the diodes are blocked, until the end of the period T, defines the discontinuous conduction mode.

From the equations 2 and 3, the conduction time t1 that is not to be exceeded (t1₍ₘₐₓ₎) for the charging device 5 to operate in discontinuous conduction mode can be defined. This time is determined by considering that the current in the inductance is canceled at T. To consider the worst case, the time t1₍ₘₐₓ₎ should be evaluated for the maximum input voltage Ve and the minimum output voltage Vs. Furthermore, the voltage drops of the diodes can be disregarded to consider the worst case.

$$t {1}_{( max )} = T \times \frac{1}{\frac{Ve}{Vs + 2 \times Vd} + 1} \qquad ( equation 4 )$$

The output current of the charging device 5 is equal to the current conducted by the diodes D1ᵢ and D₂i. The average output current of a charging device 5 is calculated from the equation 5. The average output current (Is_{(avg)}) is proportional to the square of the input voltage Ve² and inversely proportional to the output voltage Vs and to the voltage drop of the diodes D1ᵢ and D2ᵢ. To supply the desired average current regardless of the voltage of the accumulator stage Etᵢ, the maximum output voltage and the minimum input voltage must be taken into account,

$${Is}_{( avg )} = \frac{1}{2} \times \frac{1}{T} \times \frac{{Ve}^{2} \times t {1}^{2}}{( Vs + 2 \times Vd ) \times L {1}_{i}} \qquad ( equation 5 )$$

The current in the charged stage or stages is not equal to the output current of the charging device 5. In fact, the energy stored by the inductance L1ᵢ of a charging device 5 is supplied by the accumulator battery 1. This current is therefore supplied by the stage or stages that is/are charged. The current supplied to the charged accumulator stage or stages is therefore equal to the algebraic sum between minus the current through the switches SW1ᵢ and SW2ᵢ plus the current conducted by the diodes D1ᵢ and D2ᵢ. By considering N, the number of charging devices 5 in operation, the average value of the current of the charged stage or stages (IEt_{(avg)}) is obtained using the equation 6. For the equation 6 below, it is considered that, over the same operating period T, the current is supplied by the battery 1 to the charging devices 5 and also from the charging devices 5 to the stages Etᵢ. If the number of charging devices 5 in operation is equal to the number of stages Etᵢ connected to the input of the charging devices 5, the average current of the stages is equal to 0.

$${IEt}_{( avg )} = \frac{1}{2} \times \frac{1}{T} \times Ipeak \times ( \frac{Ipeak \times L {1}_{i}}{Vs + 2 \times Vd} - t 1 \times N ) \qquad ( equation 6 )$$

### EXAMPLES

To illustrate the equations introduced previously, the dimensioning of two charging devices 5 is considered.

The first relates to a charging device 5 which can be used to continue the charging of a stage Etᵢ and which is connected to the terminals of ten stages.

The second relates to a charging device 5 which can be used to continue the charging of a series association of ten stages and which is connected to the terminals of a hundred stages, that is to say, to the terminals of ten series associations, each therefore consisting of ten stages in series.

The dimensioning of the charging device 5 is divided into 2 steps, namely, first of all, the calculation of the conduction time t1 of the switches SW1ᵢ and SW2ᵢ for an operation of the charging device 5 in discontinuous conduction mode (equation 4), then, the calculation of the value L1ᵢ to supply, at the output of the charging device the desired average current (equation 5).

The assumptions for the dimensioning of the two charging devices 5 are as follow
average output current (minimum, Is_{(avg)}): 1 A
operating frequency (F): 50 kHz, that is T=1/F=20 μs
voltage of an accumulator (Li-ion based on iron phosphate):
   minimum voltage: 2.5 V
   maximum voltage: 3.6 V
voltage drop in the passing state of the diodes (Vd):
   fast diode (Schottky type): 0.3 V-0.7 V
   bipolar diode: 0.6 V-1.0 V

For the two charging devices 5, the time t1₍ₘₐₓ₎ is calculated by using the minimum voltage drop of the diodes D1ᵢ and D2ᵢ, the maximum input and minimum output voltage of the charging device. Then, the maximum inductance L1ᵢ is calculated by using the maximum voltage drop of the diodes and the minimum input and maximum output voltage of the charging device 5.

For a charging device 5 that can be used to charge a stage Etᵢ, the time t1 and the inductance L1ᵢ are given below (result 1). Fast Schottky-type diodes are taken into account.

$$t {1}_{( max )} = T \times \frac{1}{\frac{Ve}{Vs + 2 \times Vd} + 1} = \frac{1}{50 \times {10}^{3}} \times \frac{1}{\frac{3.6 \times 9 + 2.5}{2.5 + 2 \times 0.3} + 1} = 1.631 μs \\ L {1}_{i} = \frac{1}{2} \times \frac{1}{T} \times \frac{{Ve}^{2} \times t {1}^{2}}{( Vs + 2 \times Vd ) \times {Is}_{( avg )}} = \frac{1}{2} \times 50 \times {10}^{3} \times \frac{{( 2.5 \times 9 + 3.6 )}^{2} \times {( 1.631 \times {10}^{- 6} )}^{2}}{( 3.6 + 2 \times 0.7 ) \times 1} = 9.1 μH \qquad ( Result 1 )$$

For a charging device 5 that can be used to charge a series association of ten stages, the time t1 and the inductance L1ᵢ are given below. Bipolar diodes are taken into account.

$$t {1}_{( max )} = T \times \frac{1}{\frac{Ve}{Vs + 2 \times Vd} + 1} = \frac{1}{50 \times {10}^{3}} \times \frac{1}{\frac{3.6 \times 10 \times 9 + 2.5 \times 9 + 3.6}{2.5 \times 9 + 3.6 + 2 \times 0.6} + 1} = 1.447 μs \\ L {1}_{i} = \frac{1}{2} \times \frac{1}{T} \times \frac{{Ve}^{2} \times t {1}^{2}}{( Vs + 2 \times Vd ) \times {Is}_{( avg )}} = \frac{1}{2} \times 50 \times {10}^{3} \times \frac{\begin{matrix}{( 2.5 \times 10 \times 9 + 3.6 \times 9 + 2.5 )}^{2} \times \\ {( 1.447 \times {10}^{- 6} )}^{2}\end{matrix}}{( 3.6 \times 9 + 2.5 + 2 \times 1 ) \times 1} = 96 μH \qquad ( Result 2 )$$

In these examples, L1 is a maximum value. However, for reasons of robustness of he system, inductances of lower values can be used.

Simulations

As an example, two simulation results are illustrated for a charging device in operation that can be used to charge a stage (FIG. 9).

The accumulator battery 1 consists in this example of a series association of ten accumulator stages each comprising an accumulator. An accumulator is represented by a voltage source Vi and an internal resistance RI in series, equal to 0.010 ohms for each accumulator. For reasons of legibility of the diagram, the accumulators above and below the accumulator that is on charge are associated to each comprise a single voltage source and a series resistance.

The operating frequency of the charging device 5 is set arbitrarily at 50 kHz.

The conduction time of the switches SW1ᵢ and SW2ᵢ is set at 1.631 μs. The value of the inductance L1ᵢ is set at 9.1 μH (cf. result 1).

First Simulation

For the first simulation, most of the accumulators are charged to the threshold voltage 2.5 V and one accumulator is charged to the voltage V₇ of 3.6 V. The charging device 5 is connected in parallel to the accumulator which has the highest charge voltage, or 3.6 V (here, the seventh). The stages below the seventh accumulator are associated with a voltage source V₁₋₆ of 15 V and an internal resistance R₁₋₆ of 0.060 ohms, and similarly the stages above the seventh accumulator are associated with a voltage source V₈₋₁₀ of 7.5 V and an internal resistance R₈₋₁₀ of 0.030 ohms.

This example illustrates the extreme case of operation for which the average output current has to be 1 A (minimum average current).

FIG. 10 represents the simulation result in which it is possible to see the current through the inductance (iL1₇) on the curve C1, the output current through the diode D2₇ (iD2₇) on the curve C2, and the current through the accumulator V₇ (iV₇) on the curve C3.

As described previously, the current iL1₇ increases in the inductance L1₇ during a conduction time t1, a time during which the switches SW1₇ and SW2₇ are closed. It is interesting to note that, during this phase, the current is supplied by the accumulator battery 1, via the current iV₇ supplied by the accumulator during this phase. At the end of the time t1, the value of the current reaches a peak value Ipeak, of the order of 4.6 A in our example. From the time t1, the current in the inductance decreases and is supplied to the accumulator. The circuit operates in discontinuous conduction mode because the current is canceled before each operating period of the charging device 5.

The average output current Is_{7(avg)} is equal to 1.0 A, as desired. A minimum average current of 1 A is well respected regardless of the voltage value of the charged accumulator and the voltage value of the accumulator battery.

Second Simulation

For the second simulation, the accumulators are mostly charged to the threshold voltage of 3.6 V and one accumulator is charged to the voltage of 2.5 V. The charging device 5 is connected in parallel to the accumulator which has the lowest charge voltage, or 2.5 V. This example illustrates the extreme case of operation for which the charging device 5 has to operate in discontinuous conduction mode.

FIG. 11 shows the simulation result in which it is possible to see the current IL1₇ through the inductance L1₇ on the curve C5, the output current iD2₇ through the diode D2₇ on the curve C6, and the current through the accumulator iV₇ on the curve C7.

As described previously, the current iL1₇ increases in the inductance L1₇ during a conduction time t1, a time during which the switches SW1₇ and SW2₇ are closed. At the end of the time t1, the value of the current reaches a peak value Ipeak, of the order of 6.1 A in our example. From the time t1, the current in the inductance decreases and is supplied to the accumulator. The circuit operates in discontinuous conduction mode because the current is canceled before each operating period of the charging device 5. The operation in discontinuous conduction mode is well observed regardless of the voltage value of the charged accumulator and the voltage value of the accumulator battery.

The average output current Is_{7(avg)} is equal to 2.3 A. It is well above the minimum value of 1 A.

Other simulations have been implemented. The charging device 5 has been validated for the entire voltage variation range of the accumulator (2.5 V-3.6 V) and of the battery 1 (25 V-36 V). The charging device 5 has also been validated regardless of the position thereof, namely at the terminals of the stage 1, of the stage 6 or of the stage N. The operation of the charging device 5 with a number of charging devices 5 operating in parallel has also been validated. The charging device 5 that can be used to charge ten stages Etᵢ in series and connected to the terminals of a hundred stages Etᵢ has also been validated by this approach.

1-14. (canceled)

15. An apparatus comprising a charge equalizing system for batteries, said charge equalizing system comprising two accumulator stages connected in series, each accumulator stage comprising one of an accumulator and two accumulators connected in parallel, wherein each accumulator stage comprises an associated charging device comprising an inductance for storing energy, said inductance having a first end and a second end, first and second diodes, wherein said first diode is linked to a negative pole of said accumulator stage by an anode thereof and linked to said first end of said inductance by a cathode thereof, and wherein said second diode is linked to a positive pole of said accumulator stage by a cathode thereof and linked to said second end of said inductance by an anode thereof, and first and second controlled switches, wherein said first switch is linked to a negative pole of a battery and to said anode of said second diode, and wherein said second controlled switch is linked to a positive pole of said battery and to said cathode of said first diode, and a control device for controlling said charging devices, said control device being configured to close said switches of a charging device associated with said accumulator stage to be charged in such a way that said inductance stores energy, and to open said controlled switches so as to transfer said energy to said associated accumulator stage.

16. The apparatus of claim 15, wherein said control device is configured to simultaneously close said first and second controlled switches of said charging device to be charged.

17. The apparatus of claim 15, wherein said control device is configured to open said controlled switches after a predefined conduction time.

18. The apparatus of claim 15, wherein said charging device is configured to operate in discontinuous conduction mode independently of said voltage levels of said associated accumulator stage and of said battery during a charge phase.

19. The apparatus of claim 17, wherein said predefined conduction time is calculated such that said charging device for each accumulator stage operates in discontinuous conduction mode.

20. The apparatus of claim 18, wherein said control device is configured to close and open said first and second controlled switches of said charging device respectively according to a conduction time and an open time that are constant during a charge phase.

21. The apparatus of claim 15, wherein said control device is configured to respectively control said charging devices at said terminals of said accumulator stages to be charged in a way that is staggered in time.

22. The apparatus of claim 15, wherein said battery comprises at least one individual module, said at least one individual module comprising a plurality of accumulator stages in series, and wherein said system further comprises an additional charging device at terminals of said at least one individual module.

23. The apparatus of claim 22, wherein said battery comprises a plurality of individual modules arranged in series, and wherein said system comprises an additional charging device at terminals of each of a predetermined number of said individual modules.

24. The apparatus of claim 15, wherein said inductance comprises an auxiliary winding for charging an ancillary power supply.

25. The apparatus of claim 15, further comprising a device for measuring voltage of each accumulator configured to transmit voltage information to said control device.

26. The apparatus of claim 15, wherein said accumulators are of lithium-ion type.

27. The apparatus of claim 15, wherein said battery comprises supercapacitors.

28. A charging device for a battery accumulator stage, said charging device comprising a charge equalizing system as recited in claim 15.
